(19) United States
(12) Patent Application Publication
(10) Pub. No.: US 2018/0349436 A1
(43) Pub. Date: Dec. 6, 2018

(54) Intelligent Data Aggregation

(71) Applicant: Yodlee, Inc., Redwood City, CA (US)

(72) Inventors: Prashant Kumar Agrawal, Bangalore (IN); Manoj Ghode, Bengalura (IN); Sujitha Modakkupatti Ravi, Bangalore (IN)

(21) Appl. No.: 15/608,555

(22) Filed: May 30, 2017

(51) Int. Cl. G06F 17/30; H04L 29/08

(52) U.S. Cl. CPC G06F 17/30424; H04L 67/42; H04L 67/101; H04L 67/2833

(57) ABSTRACT

Methods, systems and computer program products for intelligent data aggregation are described. A data aggregation system receives a request for aggregating data from a target site. The data aggregation system parses the request and dynamically determines what data items need be scraped for a specific request. The data aggregation system controls flow based on a sitemap through life of the request. The sitemap of the target site includes configuration capturing multiple possible navigational flows. Based on the sitemap, the data aggregation system identifies a shortest path to access the data item required by the request. The data aggregation system creates, for each request, a site flow based on the shortest path. The data aggregation system manages and invokes different modules in an agent that follows the site flow to gather data. The data aggregation system executes the agent to retrieve the requested data items.

### TECHNICAL FIELD

This disclosure relates generally to data gathering and analysis.

### BACKGROUND

A data aggregation platform enables aggregation of data from various sources, e.g., websites, by executing a data scraping script. The data scraping script contains navigation steps for navigating each website and scraping steps for retrieving the data. A conventional data aggregation platform executes static data scraping scripts. Each static data scraping script corresponds to a specific website. Data aggregation using a static data scraping script is limited to scraping data by defining a respective set of fixed steps to navigate and scrape data for each website. Different websites may require different scripts. What data to scrape and what not to scrape from a website depend on the particular data scraping script for that website.

### SUMMARY

Techniques of intelligent data aggregation are disclosed. An intelligent data aggregation platform (iDAP) provides a centralized framework to have a dynamically controlled flow via sitemap for different scripts and various data items being aggregated. A data aggregation system receives a request for aggregating data from a target site. The data aggregation system parses the request and dynamically determines what data items need be scraped for a specific request. The data aggregation system controls flow based on a sitemap through life of the request. The sitemap of the target site includes configuration capturing multiple possible navigational flows. Based on the sitemap, the data aggregation system identifies a shortest path to access the data item required by the request. The data aggregation system creates, for each request, a site flow based on the shortest path. The data aggregation system manages and invokes different modules in an agent that follows the site flow to gather data. The data aggregation system executes the agent to retrieve the requested data items.

The data aggregation system can segregate agents that aggregate data based on functionality of the agents and what actions the agents perform. An agent includes one or more modules to navigate a target site and scrape data from the target site. The data aggregation system provides a framework or a structure to the agent that can segregate the agents based on whether action performed is scraping or navigating.

In some implementations, a data aggregation system receives a request from a client device. The request is a request to retrieve a data item from a target site. The data aggregation system receives or generates a sitemap of the target site. The sitemap specifies paths to navigate the target site. The data aggregation system determines, based on the sitemap, a shortest path to navigate from an initial page of the target site to a page including the data item. The data aggregation system determines a set of one or more rules of scraping the data item from the page including the data item. The data aggregation system generates one or more paths for navigating the target site following the shortest path and scraping the data item following the one or more rules. The data aggregation system then executes one or more scripts to retrieve the data item during traversing the path. The data aggregation system provides the data item to the client device as a response to the request.

The features described in this specification can achieve one or more advantages. For example, compared to conventional data aggregation systems, the disclosed techniques can dynamically organize the scripts for navigating a target site and scripts for scraping data. The dynamic script generation improves scalability, flexibility and reliability. The disclosed techniques use machine learning to generate sitemaps for target sites. Accordingly, the system is scalable and is able to handle a large number of diverse target sites having different flows. The system is scalable. For example, the system can handle situations where new flows are added to the target sites, and new data needs to be scraped to solve different solution needs. These situations may be challenging to a conventional data scraping system. The disclosed techniques provide a flexible way of aggregating data, where changes of flow on a target site, e.g., a loss of a link from one page or another, does not break the data gathering because the disclosed techniques can identify alternative routes. The disclosed techniques are reliable, where changes or failures on a target site can be accommodated.

The segregation of navigation and scraping allows a data aggregation system to have better control on execution of an agent. Centralization of exception handling and business logic that are common across the agents in the data aggregation system improves maintainability.

The discloses techniques can be implemented in various information gathering systems. For example, a surveying organization can use the disclosed techniques to gather consumer behavior information. A research institute can use the disclosed techniques to gather health information, e.g., diet habit, from a large number of provider websites. A financial service company can provide periodic aggregated financial report on users' transactions.

The details of one or more implementations of the disclosed subject matter are set forth in the accompanying drawings and the description below. Other features, aspects and advantages of the disclosed subject matter will become apparent from the description, the drawings and the claims.

### BRIEF DESCRIPTION OF THE DRAWINGS

FIG. 1 is a block diagram illustrating an example workflow of intelligent data aggregation.

FIG. 2 is a block diagram illustrating components of an example data aggregation system.

FIG. 3 is a flowchart illustrating an example process of state execution.

FIG. 4 is a flowchart illustrating an example process of intelligent data aggregation.

FIG. 5 is a block diagram of an example system architecture for implementing the systems and processes of FIGS. 1-4.

Like reference symbols in the various drawings indicate like elements.

### DETAILED DESCRIPTION

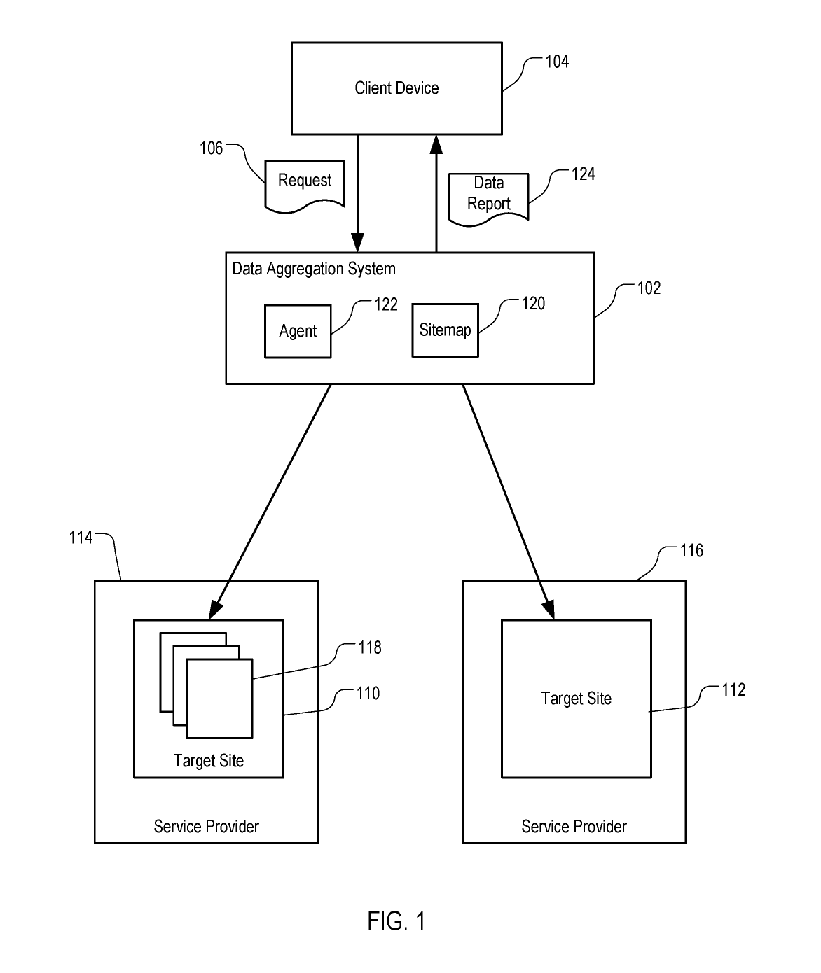

FIG. 1 is a block diagram illustrating an example workflow of intelligent data aggregation. A data aggregation system 102 receives, from a client device 104, a request 106 to aggregate data and generate a report on the aggregated data. The data aggregation system 102 can include one or more computers operated by a data aggregation service. The client device 104 can include one or more computers operated by an end user or a data analysis organization. The request 106 can include one or more documents, e.g., XML (extensible markup language) or JSON (JavaScript object notation) documents specifying a general requirement of the end user or data analysis organization. The general requirement can specify a scope of the data to be aggregated. For example, the request 106 can include a parameterized XML, document specifying “give me all student grade data from sites 110 and 112.” A site that is specified in the request 106, or that the data aggregation system 102 determines to visit to retrieve data, can be referred to as a target site.

In response to the request, the data aggregation system 102 aggregates data from target sites 110 and 112. Aggregating data includes gathering data from each of the target sites 110 and 112 and putting the gathered data into one or more reports. A report can include one or more document e.g., XML (extensible markup language) or JSON (JavaScript object notation) documents or a PDF or a file in some other format to provide requested data. The data can optionally be enriched before it gets provided to client. The target sites 110 and 112 can be websites. Gathering the data can include scraping the websites using one or more scripts. Each of the target sites 110 and 112 can correspond to a respective service provider, e.g., service provider 114 and service provider 116. The service providers 114 and 116 can provide service of various types, e.g., student information management, medical record repository, or financial transaction management. In this example, the service providers 114 and 116 are two different schools that a particular student attended. In various implementations, service providers 114 and 116 can be two different financial institutes, e.g., banks or credit card companies, where a customer performs various transactions, e.g., deposit, withdrawal or trade.

The target sites 110 and 112 can be significantly different from one another. The data aggregation system 102 generates sitemaps for the target sites 110 and 112. The data aggregation system 102 can generate the sitemaps prior to receiving the request 106. The data aggregation system 102 can generate the sitemaps using various techniques, e.g., web crawling and machine learning. In some implementations, the sitemaps are predefined and are pre-stored on the data aggregation system 102. Typically, the target sites 110 and 112 have different flows. Accordingly, the sitemaps for the target sites 110 and 112 are different from one another.

For example, target site 110 can be a website having multiple webpages 118. The webpages 118 can include a homepage, where a client device can login. After logging in, the client device can navigate from the homepage to various other pages of the webpages 118. On each page, the client device can retrieve certain information. For example, on a first page of a student information management website, the client device can retrieve grades of a specific semester of a student; on a second page the client device can retrieve cumulative grade point average (GPA) of the student, and so on. To access a particular data item, e.g., a grade of a particular course in a particular semester, there may be different paths. For example, the client device can access the homepage, navigate to the GPA page, then to the GPA details page, or directly to a semester page, then prompted for login, and to the GPA details page, and so on. The data aggregation system 102 can determine the various paths, and store the paths and associated data items in a sitemap 120. The data aggregation system 102 can determine the various paths using user provided login credentials.

The data aggregation system 102 then aggregates the data using one or more agents 122. Different target sites correspond to different agents. The agents can be pre-generated, or automatically learned using various machine learning or other techniques to adapt to site changes. An agent 122 includes one or more executable scripts. A script specifies navigation or scrapping steps including actions to be performed on a specific target site to scrape data. A script, when executed, can navigate between pages on a target site or gather data from a page on the target site. Scripts can be segregated, where a navigation script of the agent 122 is a script dedicated to perform tasks of navigating between the webpages 118, and a scraping script is a script dedicated to perform tasks of retrieving one or more data items from a page.

The data aggregation system 102 parses the request 106 and determines data items to be aggregated for the request 106. For example, the data aggregation system 102 can determine that by requesting all grade data on target sites 110 and 112, the data aggregation system 102 shall get detailed grades for each course in each semester for a particular student from the webservers of the target sites 110 and 112. The data aggregation system 102 identifies respective sitemaps, including sitemap 120, associated with the target sites. The data aggregation system 102 defines and controls navigation over the target sites 110 and 112 and data scraping over the target sites 110 and 112 using the agent 122, based on the sitemap 120. The data aggregation system 102 then executes the agent 122 to scrape the corresponding data items. The data aggregation system 102 aggregates the data scraped from the target sites 110 and 112 to generate a data report 124. The data aggregation system 102 provides the data report 124 to the client device 104, or another data consumer, as a response to the request 106.

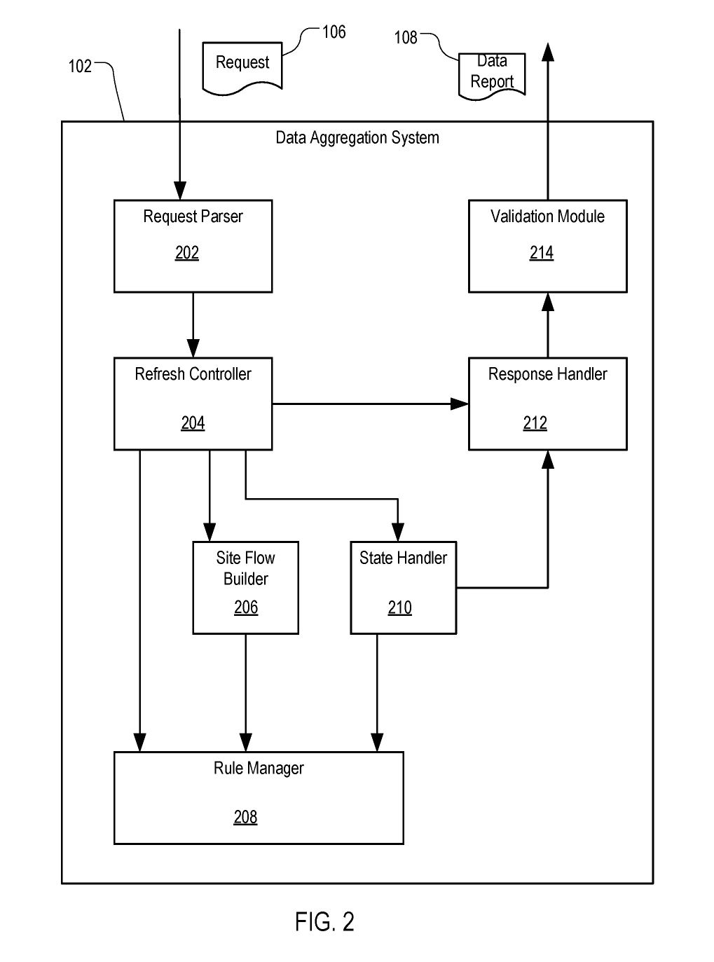

FIG. 2 is a block diagram illustrating components of an example data aggregation system 102. The data aggregation system 102 is configured to receive a request 106 from a client device, either directly or through one or more intermediate components.

The data aggregation system 102 includes a request parser 202. The request parser 202 includes software and hardware components configured to parse and validate the request 106. Based on routing configuration, the request parser 202 routes the request 106 to a refresh controller 204. The request parser 202 triggers a browser startup based on a browser version specified in the request. The browser can be any modern browser with head, e.g., a browser with a graphical user interface (GUI), or without head, e.g., a browser that does not have a GUI and perform actions through command line interface. In various implementations, the data aggregation system 102 can use other tools, instead of a browser, for Web scraping or crawling.

The refresh controller 204 is a subsystem of the data aggregation system 102 including hardware and software components. The refresh controller 204 is configured to handle a refresh execution. A refresh execution specifies which agent to invoke. The refresh execution performs necessary initialization. The refresh execution is a central controller for the rest of the execution and processing for the request. The refresh controller 204 can trigger the part of the refresh request completion or failure events.

The data aggregation system 102 includes a site flow builder 206. The site flow builder 206 is a subsystem of the data aggregation system 102 including hardware and software components. The site flow builder 206 defines a path for scraping data. The path can be a series of page visits from a starting page to reach a data item to be retrieved. The start page can include a landing page, e.g., a home page or login page. The site flow builder 206 can determine a shortest path from the starting page to the data item based on a sitemap. The site flow builder 206 can designate one or more factors as costs for determining the shortest path. The factors can include, for example, number of page hops, authentication requirements, and latency. The site flow builder 206 can designate smaller number of page hops, smaller number of authentications, and small amount of latency between page transitions as lower costs in calculating the shortest path.

Target sites can significantly vary from one another. The site variations can be user specific. Conventionally, the user specific variation can require complex agent code to support all the variations. Whereas, in data aggregation system 102, navigational and page variations of pages are represented in site flows which make agent code precise for specific variations. The site flow builder 206 is configured to build a site flow based on the shortest path as identified in the sitemap. The site flow builder 206 builds a site graph from a site map for various states. The site flow builder 206 can identify a shortest path using various algorithms, e.g., a spanning tree algorithm.

The site flow builder 206 can construct a site flow in JSON format. The site flow can include one or more sections specifying different stages of data scraping. The stages include a pre-execution stage, an execution stage, and a completion stage, labeled as such respectively in this example. The pre-execution stage is a logical grouping of entry flows for a target site. The execution stage is a logical grouping of flows of scraping data from the target site. The completion stage is a logical grouping of exit flows for the target site. Each stage can have a respective state and a respective identity. A state is a representation of one or more pages at a target site corresponding to a respective group of inter-related data items. Examples of a state include a login state, an initial state and a logout state. An identity field, e.g., a field labeled as “id,” can store an identifier of a corresponding stage.

A data gatherer has control over repeating the states for data items to be aggregated based on the repeat behavior of the state executional dependencies defined in the site flow. For instance, in a multi-account scenario, a user might have one or more accounts listed in the target site. For each account, the system needs to get transactions and details. For repeating the transactions and details state for all the accounts, the site flow specifies a repeat attribute for the states “transactions” and “details.”

A stage can have one or more subsections. Each subsection can be associated with a state that corresponds to a sub-group of the inter-related data items. Each subsection can include nested subsections. Each subsection can correspond to content on one or more pages of the target set. Each subsection can include a “repeat” attribute. A repeat attribute in the site flow specifies whether a state has to be repeated. The value of the repeat attribute can be either self or one of the parent states. The value of a repeat attribute can be “self” if a particular state does not have any dependency on its parent state for getting the data for next iteration, e.g., data of next account in the multi-account scenario. The value of a repeat attribute can be a name of the parent state if the state has dependency on its parent for getting data for next iteration.

Each of the refresh controller 204 and the site flow builder 206 can communicate with a rule manager 208. The rule manager 208 is a subsystem of the data aggregation system 102 including hardware and software components. The rule manager 208 is configured to control execution of the agent based on one or more rules as per request. The rules can be predefined. A rule can be a state rule or a behavior rule. A state rule specifies on which conditions the state has to be executed or not executed. A behavior rule specifies the attributes of the request received which defines the specific behavior, which will then be used in state rules as needed. Each rule can be represented in a configuration file or in a rule database. Each rule can have a name. A rule can specify a set of one or more pre-conditions. A precondition can include an execution rule specifying applicability of the rule for the request. A rule can include one or more on-success rules specifying next set of actions to be performed on successful execution of the rule, one or more on-failure rules specifying actions to perform on failed execution of the rule, and one or more on-skipped rules specifying actions to perform when execution of the rule is skipped. Each of these can be independently be defined, to continue the rule execution, or confirm invocation of the agent state or fail by throwing error, etc. A rule can specify a set of one or more post-execution rules. A post-execution rule can specify actions to perform after an agent state is executed.

The rule manager 208 can dynamically define the behavior of the component interacting with it based on the configured rules for every state, based on what request parameters and refresh behavior the state has to be included or excluded for execution. In addition, the rule manager 208 manages the configured meta information of each state. The meta information can include, for example, a type and classification of the state, states that depends from the state, and so on. The configuration can define the behavior of the state's execution.

The refresh controller 204 can check with the rule manager 208 to determine whether a rule specifies that a current refresh needs to be continued or some action has to be taken. The site flow builder 206 can check with the rule manager 208 to determine the states that need to be executed for the current scope of the request processing.

The data aggregation system 102 includes a state handler 210. The state handler 210 is a subsystem of the data aggregation system 102 including hardware and software components. The state handler 210 is configured to handle agent execution, including transitioning from a first state to a second state, and perform various actions as specified by a rule in a state and during a transition. The agent, e.g., the agent 122 of FIG. 1, is modularized into functional groups of same states representing each or group of pages at the target site. The modular structure facilitates customized data gathering. For example, Account Summary, Account Details, Transactions, Statements etc. can all be handled separately and in customized manner. The modular structure also facilitates easy auto generation of agent code.

The state handler 210 can check with the rule manager 208 to determine whether a rule specifies that a specific state needs to be executed. To execute a state includes executing a script to retrieve one or more data items corresponding to the state. The state handler 210 can trigger state completion or state failure events. The events can include data items scraped from the pages.

A response handler 212 receives the events from the state handler 210 and the refresh controller 204. The response handler 212 is a subsystem of the data aggregation system 102 including hardware and software components. The response handler 212 is configured to handle and control response sending. The response handler 212 can also perform post state execution tasks like providing data presented by the events to a validation module 214, data cleansing, etc.

The validation module 214 is a subsystem of the data aggregation system 102 including hardware and software components. The validation module 214 can validate data provided by the response handler 212 and log data report 108. The validation module 214 can act on result of the validation, including, for example, mark a validation as success, warn, or fail. The validation module 214 can perform data cleansing and normalization, in case required. The response handler 212 can provide the data report 108 to a client device. The validation module can dynamically control the submission various responses based on the request and the data set scraped at the end of every state execution.

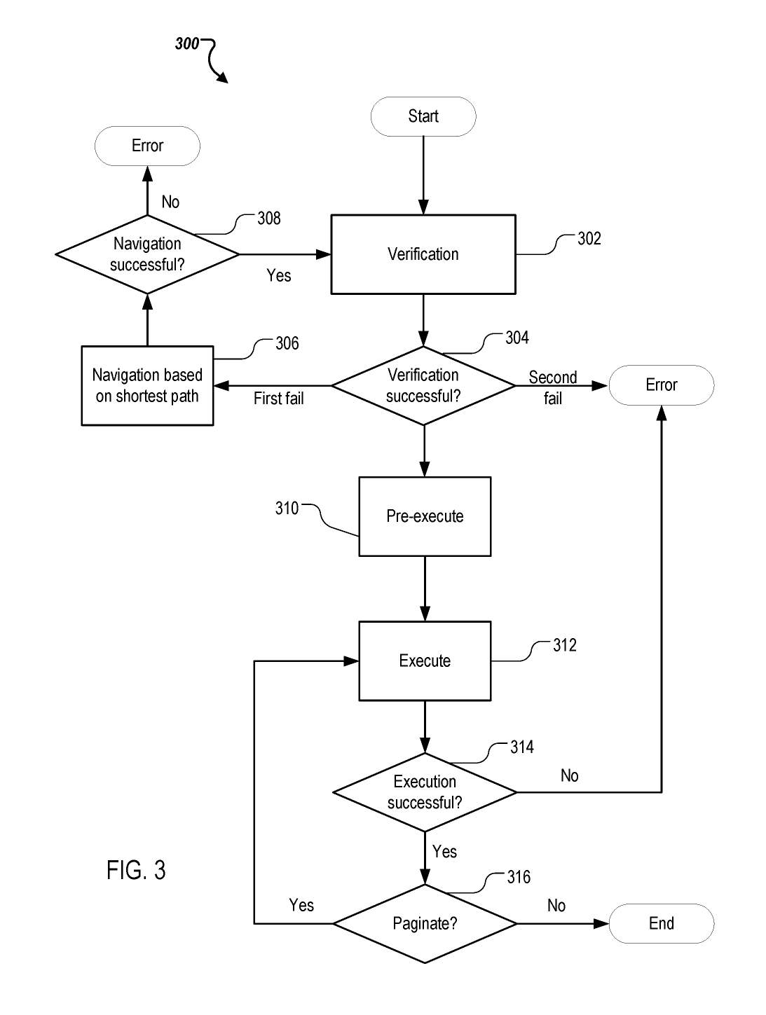

FIG. 3 is a flowchart illustrating an example process 300 of state execution. The process 300 can be performed by a state handler, e.g., the state handler 210 of FIG. 2. The state execution includes executing an agent to retrieve data items corresponding to a state, e.g., detailed course grade information. The agent can include one or more scripts.

The state handler verifies (302) whether the control or the loaded web page is for the corresponding state or a data set. The data set includes at least a portion of the data items to be scraped. The state handler determines (304) whether the verification is successful. In response to determining that the verification failed, the state handler determines whether the failure is the first time that the verification failed for a particular request. In response to determining that the failure is the second time that the verification failed, the state handler throws an error and terminates the process 300.

In response to determining that the failure is the first time that the verification failed, the state handler navigates (306) to the state following a shortest path. The state handler determines (308) whether the navigation is successful. In response to determining that the navigation is successful, the state handler verifies (302) whether the agent is in the state. In response to determining that the navigation is unsuccessful, the state handler throws an error and terminates the process 300.

Upon determining that the verification is successful at stage 304, the state handler pre-executes (310) the agent. Pre-executing includes executing a pre-execution module of the script of the agent. The pre-execution module can include actions to take before data scraping, for example, prefilling a form to fetch or scrape the data. The state handler then executes (312) the state. Executing the state can include executing one or more data gathering scripts to retrieve data items corresponding to the state. Data items are retrieved and processed at this stage.

The state handler determines (314) whether the execution at stage 312 is successful. In response to determining that the execution is unsuccessful, the state handler throws an error or terminates the process 300 based on the rules defined. In response to determining that the execution is successful, the state handler determines whether to paginate 316. Paginating includes navigating from one page to another. In response to determining that no paginating is necessary, the state handler terminates the current state. In response to determining that paginating is necessary, the state handler paginates and continues execution of stage 312.

A data aggregation system can provide interfaces and APIs with exception handling and event handling the agent to perform actions on target sites. The system can process the errors thrown during process 300.

Alternative to or in addition to specifying a general term for data aggregation, a request may explicitly specify certain data items. The agent can scrape these items as part of any state or independently based on their presence on the target site. During agent compilation, a data aggregation system can generate a field map as a part of an agent meta file which represents in which state the explicitly specified data items belong. The agent uses this field map during the required states filtering for a specific request. The field map design can avoid any agent changes if a new field is requested where that new field is already scraped by the agent. The new field and the corresponding rules can be configured in the agent.

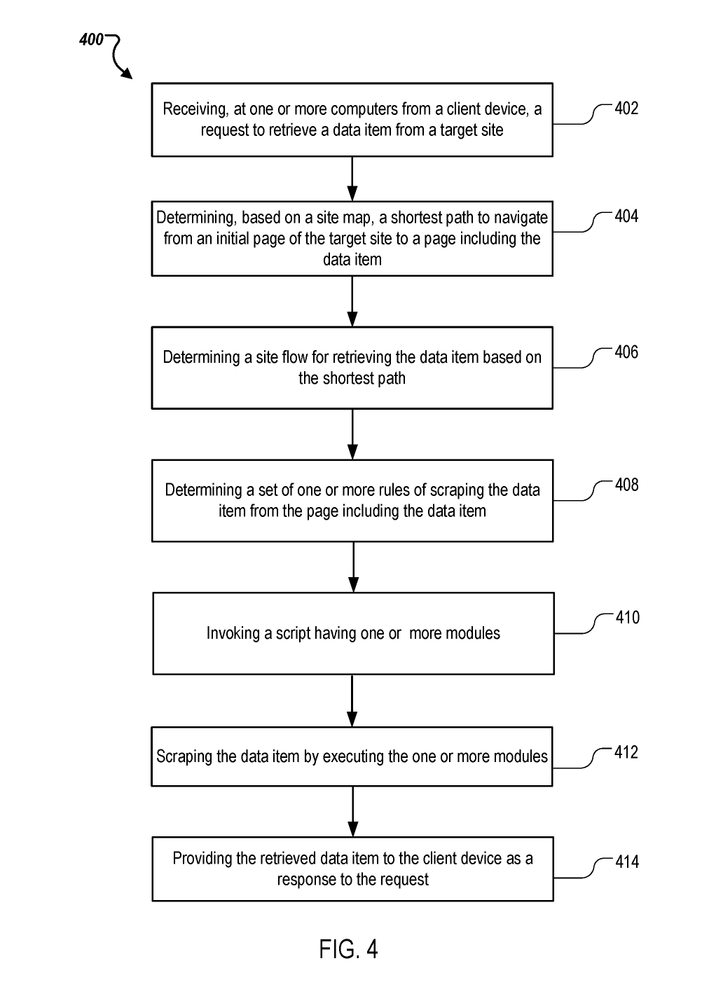

FIG. 4 is a flowchart illustrating an example process 400 of intelligent data aggregation. The process 400 can be executed by a system having one or more computers, e.g., the data aggregation system 102 of FIG. 1.

The system receives (402), from a client device, a request to retrieve one or more data item from a target site. The target site can be a website including multiple inter-linked webpages. The request can include an XML document or a JSON document. The system can determine the one or more data items from the request. For example, when the request specifies that detailed academic grade information is to be retrieved, the system can determine that the one or more data items include a course name, a course semester, and a course grade. Determining the one or more data items can include parsing the XML document or JSON document to identify a scope of the request and determining the one or more data items based on the scope.

The system determines (404), based on a site map of the target site, a shortest path to navigate from an initial page of the target site to a page including the data item. The initial page can be a landing page, e.g., a home page, a login page, or both.

The system determines (406) a site flow for retrieving the data item based on the shortest path. The site flow can include a JSON document that specifies a pre-execution stage, an execution stage, and a completion stage. Each stage can be associated with at least one respective state. Each state includes a respective set of one or more pages of the target site that correspond to a respective group of data items. For example, the pre-execution stage can correspond to a login state, the execution stage can correspond to multiple states and sub-states, and the completion stage can include a logout state.

The system determines (408) a set of one or more rules of scraping the data item from the page. The one or more rules can be predefined based on functional requirement for scraping the target site.

The system manages and invokes (410) a script that includes one or more modules. Each module has one or more definitions of one or more actions on how to navigate the target site according to the site flow.

The system scrapes (412) the data item from the page by executing the one or more modules to perform the one or more respective actions, including navigating to the initial page to the page including the data item following the shortest path. Executing the one or more modules can include the following operations. The system can determine whether a data gatherer, e.g., a state, is on the page including the data item. Upon determining that the data gatherer is not on the page, the system navigate to the page according to the shortest path. The system determines, again, whether a data gatherer is on the page. Upon determining that the data gatherer is on the page, the system executes a pre-execution flow of the script or state as specified in the site flow. Upon finishing the pre-execution flow, the system executes a data gathering module of the script or state. Upon finishing the execution stage for all the determined scripts, the system executes scripts specified in the completion stage of the site flow. The system retrieves the data item in the execution stage.

The system provides (414) the retrieved data item to the client device as a response to the request. Providing the retrieved data item to the client device can include the following operations. The system retrieves a second data item from a second target site as specified in the request. The system aggregates the data item and the second data item in a report. The system then provides the report to the client device.

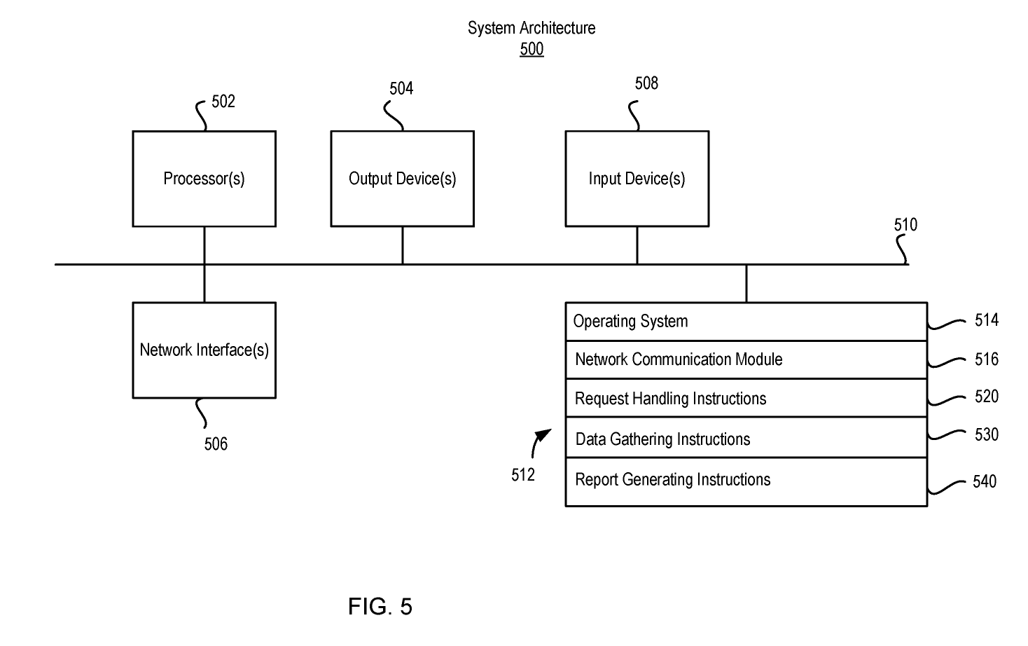

FIG. 5 is a block diagram of an example system architecture for implementing the systems and processes of FIGS. 1-4. Other architectures are possible, including architectures with more or fewer components. In some implementations, architecture 500 includes one or more processors 502 (e.g., dual-core Intel® Xeon® Processors), one or more output devices 504 (e.g., LCD), one or more network interfaces 506, one or more input devices 508 (e.g., mouse, keyboard, touch-sensitive display) and one or more computer-readable mediums 512 (e.g., RAM, ROM, SDRAM, hard disk, optical disk, flash memory, etc.). These components can exchange communications and data over one or more communication channels 510 (e.g., buses), which can utilize various hardware and software for facilitating the transfer of data and control signals between components.

The term “computer-readable medium” refers to a medium that participates in providing instructions to processor 502 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 512 can further include operating system 514 (e.g., a Linux® operating system), network communication module 516, request handling instructions 520, data gathering instructions 530 and report generating instructions 540. Operating system 514 can be multi-user, multiprocessing, multitasking, multithreading, real time, etc. Operating system 514 performs basic tasks, including but not limited to: recognizing input from and providing output to devices 506, 508; keeping track and managing files and directories on computer-readable mediums 512 (e.g., memory or a storage device); controlling peripheral devices; and managing traffic on the one or more communication channels 510. Network communications module 516 includes various components for establishing and maintaining network connections (e.g., software for implementing communication protocols, such as TCP/IP, HTTP, etc.).

The request handling instructions 520 can include computer instructions that, when executed, cause processor 502 to perform functions of the request parser 202 of FIG. 2. The data gathering instructions 530 can include computer instructions that, when executed, cause processor 502 to perform operations of the gathering data from one or more target sites, including operations of the refresh controller 204, site flow builder 206, rule manager 208, state handler 210, response handler 212 of FIG. 2. The report generating instructions 540 can include computer instructions that, when executed, cause processor 502 to perform operations of the validation module 214, including generating a data report and providing the data report to a client device.

Architecture 500 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

What is claimed is:

1. A method comprising:
receiving, at one or more computers from a client device, a request to retrieve a data item from a target site;
determining, based on a site map of the target site, a shortest path to navigate from an initial page of the target site to a page including the data item;
determining a site flow for retrieving the data item based on the shortest path;
invoking a script having one or more modules, each module having one or more definitions of one or more actions for navigating the target site according to the site flow; and
scraping the data item from the page by executing the one or more modules to perform the one or more respective actions, including navigating from the initial page to the page including the data item following the shortest path.

2. The method of claim 1, wherein the target site is a website, and the initial page is a landing page.

3. The method of claim 1, comprising determining the data item from the request, wherein the request includes an Extensible Markup Language (XML) document or a JavaScript Object Notation (JSON) document, and determining the data item comprises parsing the XML document or JSON document to identify a scope of the request and determining the data item based on the scope.

4. The method of claim 1, wherein the site flow includes a JavaScript Object Notation (JSON) document that specifies a pre-execution stage, an execution stage, and a completion stage, each stage being associated with at least one respective state, each state including a respective set of one or more pages of the target site that correspond to a respective group of data items.

5. The method of claim 4, wherein the pre-execution stage corresponds to a common initial state for different data items, the execution stage corresponds to a plurality of states and sub-states, and the completion stage includes a common completion state.

6. The method of claim 5, wherein the common initial state is a login state, and the common completion state includes a logout state.

7. The method of claim 4, wherein executing the one or more modules of the script comprises:
determining whether a data gatherer is on the page including the data item;
upon determining that the data gatherer is not on the page, navigating to the page according to the shortest path;
re-determining whether a data gatherer is on the page;
upon determining that the data gatherer is on the page, pre-executing a pre-execution flow as specified in the pre-execution stage of the site flow to prepare for data item retrieval;
upon finishing the pre-execution flow, executing a data gathering module of the script; and
upon finishing executing the data gathering module of the script, executing one or more scripts as specified in the completion stage of the site flow to clean up the data item retrieval.

8. The method of claim 1, comprising providing the scraped data item to the client device, wherein providing the retrieved data item comprises:
retrieving one or more data items from the target site as specified in the request;
aggregating all data items in a report; and
providing the report to the client device.

9. A system comprising:
one or more processors; and
a non-transitory computer-readable medium storing instructions that, when executed by the one or more processors, cause the one or more processors to perform operations comprising:
receiving, from a client device, a request to retrieve a data item from a target site;
determining, based on a site map of the target site, a shortest path to navigate from an initial page of the target site to a page including the data item;
determining a site flow for retrieving the data item based on the shortest path;
invoking a script having one or more modules, each module having one or more definitions of one or more actions for navigating the target site according to the site flow; and
scraping the data item from the page by executing the one or more modules to perform the one or more respective actions, including navigating from the initial page to the page including the data item following the shortest path.

10. The system of claim 9, wherein the site flow includes a JavaScript Object Notation (JSON) document that specifies a pre-execution stage, an execution stage, and a completion stage, each stage being associated with at least one respective state, each state including a respective set of one or more pages of the target site that correspond to a respective group of data items.

11. The system of claim 10, wherein the pre-execution stage corresponds to a common initial state for different data items, the execution stage corresponds to a plurality of states and sub-states, and the completion stage includes a common completion state.

12. The system of claim 11, wherein the common initial state is a login state, and the common completion state includes a logout state.

13. The system of claim 10, wherein executing the one or more modules of the script comprises:
determining whether a data gatherer is on the page including the data item;
upon determining that the data gatherer is not on the page, navigating to the page according to the shortest path;
re-determining whether a data gatherer is on the page;
upon determining that the data gatherer is on the page, pre-executing a pre-execution flow as specified in the pre-execution stage of the site flow to prepare for data item retrieval;
upon finishing the pre-execution flow, executing a data gathering module of the script; and
upon finishing executing the data gathering module of the script, executing one or more scripts as specified in the completion stage of the site flow to clean up the data item retrieval.

14. The system of claim 9, the operations comprising providing the scraped data item to the client device, wherein providing the retrieved data item comprises:
retrieving one or more data items from the target site as specified in the request;
aggregating all data items in a report; and
providing the report to the client device.

15. A non-transitory computer-readable medium storing instructions that, when executed by one or more more processors to perform operations comprising:
receiving, from a client device, a request to retrieve a data item from a target site;
determining, based on a site map of the target site, a shortest path to navigate from an initial page of the target site to a page including the data item;
determining a site flow for retrieving the data item based on the shortest path;
invoking a script having one or more modules, each module having one or more definitions of one or more actions for navigating the target site according to the site flow; and
scraping the data item from the page by executing the one or more modules to perform the one or more respective actions, including navigating from the initial page to the page including the data item following the shortest path.

16. The non-transitory computer-readable medium of claim 15, wherein the site flow includes a JavaScript Object Notation (JSON) document that specifies a pre-execution stage, an execution stage, and a completion stage, each stage being associated with at least one respective state, each state including a respective set of one or more pages of the target site that correspond to a respective group of data items.

17. The non-transitory computer-readable medium of claim 16, wherein the pre-execution stage corresponds to a common initial state for different data items, the execution stage corresponds to a plurality of states and sub-states, and the completion stage includes a common completion state.

18. The non-transitory computer-readable medium of claim 17, wherein the common initial state is a login state, and the common completion state includes a logout state.

19. The non-transitory computer-readable medium of claim 16, wherein executing the one or more modules of the script comprises:
determining whether a data gatherer is on the page including the data item;
upon determining that the data gatherer is not on the page, navigating to the page according to the shortest path;
re-determining whether a data gatherer is on the page;
upon determining that the data gatherer is on the page, pre-executing a pre-execution flow as specified in the pre-execution stage of the site flow to prepare for data item retrieval;
upon finishing the pre-execution flow, executing a data gathering module of the script; and
upon finishing executing the data gathering module of the script, executing one or more scripts as specified in the completion stage of the site flow to clean up the data item retrieval.

20. The non-transitory computer-readable medium of claim 15, the operations comprising providing the scraped data item to the client device, wherein providing the retrieved data item comprises:
retrieving one or more data items from the target site as specified in the request;
aggregating all data items in a report; and
providing the report to the client device.
